(19) United States
(12) Patent Application Publication
(10) Pub. No.: US 2012/0107441 A1
(43) Pub. Date: May 3, 2012

(54) MOLD HAVING PUSH-OUT STRUCTURE

(75) Inventors: JIAN-MING LI, Tu Cheng (TW); Xiao-ping Wu, Tu Cheng (TW); Shih-hsiung Ho, Tu Cheng (TW)

(73) Assignee: Cheng Uei Precision Industry Co., LTD., Tu Cheng City (TW)

(21) Appl. No.: 12/916,534

(22) Filed: Oct. 30, 2010

(51) Int. Cl. B28B 7/10

(52) U.S. Cl. 425/443

(57) ABSTRACT

Disclosed is a mold, comprising a fixed half, a moving half, a push-out structure and a return protection system. The moving half has a pressing part. The push-out structure is installed on the fixed half. The push-out structure comprises a push-out element and a push-out plate. The return protection system comprises a return pin and an elastic element, installed between the return pin and the push-out element. The pressing part can press against the return pin. With the elastic element, the return pin can drive the push-out structure. It can prevent the moving half to interfere the push-out element and to impact the fixed half. Accordingly, the lifetimes of the push-out structure and the parting planes of the mold can be extended to reduce the maintenance cost. Noise caused by closing mold with high speed can be prevented to raise the stability and the productivity of manufacture.

### BACKGROUND OF THE INVENTION

1. Field of the Invention

The present invention generally relates to a mold, and more particularly to a mold having push-out structure.

2. Description of Prior Art

The push-out structure of the mold, employed to push out the product from the mold a fixed half, a mixing half and a push-out structure. The fixed half comprises a cavity fixing plate, a lower fixing plate fixed under the cavity fixing plate, a pair of spacing blocks positioned between the cavity fixing plate and the lower fixing plate. A fixed half cavity is fixed on the cavity fixing plate. An accepting space is formed by the cavity fixing plate, the lower fixing plate and the two spacing blocks surrounding. The push-out structure comprises an upper push-out plate, a lower push-out plate and a plurality of push-out elements. The upper push-out plate and the lower push-out plate are fixed as one body and up and down movably accepted in the accepting space. The push-out elements are installed on the upper push-out plate and fixed by the upper push-out plate and the lower push-out plate. The tops of the push-out elements can extend out of the parting plane of the fixed half. Accordingly, the push-out elements can push out the product when the mold is opened.

However, as the aforesaid mold having the push-out structure is closed, the moving half will be closed and interfere the push-out structure before the push-out structure is not in position completely. Consequently, the parting planes of the push-out elements and the moving half can be crashed and damaged. Besides, there is loud noise caused because the moving half is crashing the fixed half with high speed at moment of completely closed. The lifetime of the mold will be effected and maintenance cost will increase.

### SUMMARY OF THE INVENTION

For solving the drawbacks of aforementioned prior art, an objective of the present invention is to provide a mold having push-out structure for preventing the moving half to interfere the push-out element and to impact the fixed half.

For realizing the aforesaid objective, the mold of the present invention comprises a fixed half, a moving half, a push-out structure and a return protection system. The moving half has a pressing part. The push-out structure is installed on the fixed half. The push-out structure comprises a push-out element and a push-out plate for fixing the push-out element. The return protection system comprises a return pin and an elastic element. The elastic element is installed between the return pin and the push-out element. The pressing part can press against the return pin to drive thereof. With the elastic element, the return pin can drive the push-out structure.

As aforementioned, as the mold having the push-out structure the present invention is closed, it can prevent the moving half to interfere the push-out element and to impact the fixed half because the return pin can drive the push-out structure with the elastic element. Accordingly, the lifetimes of the push-out structure and the parting planes of the mold can be extended to reduce the maintenance cost. Noise caused by closing mold with high speed can be prevented to raise the stability and the productivity of manufacture.

### BRIEF DESCRIPTION OF THE DRAWINGS

FIG. 1 shows a diagram of a mold having a push-out structure of the present invention.

FIG. 2 shows a diagram of the mold having the push-out structure shown in FIG. 1 in an open status.

FIG. 3 shows a magnified diagram of IV portion shown in FIG. 2.

FIG. 4 shows an exploded view diagram of a return protection system of the mold having the push-out structure shown in FIG. 1.

### DETAILED DESCRIPTION OF THE INVENTION

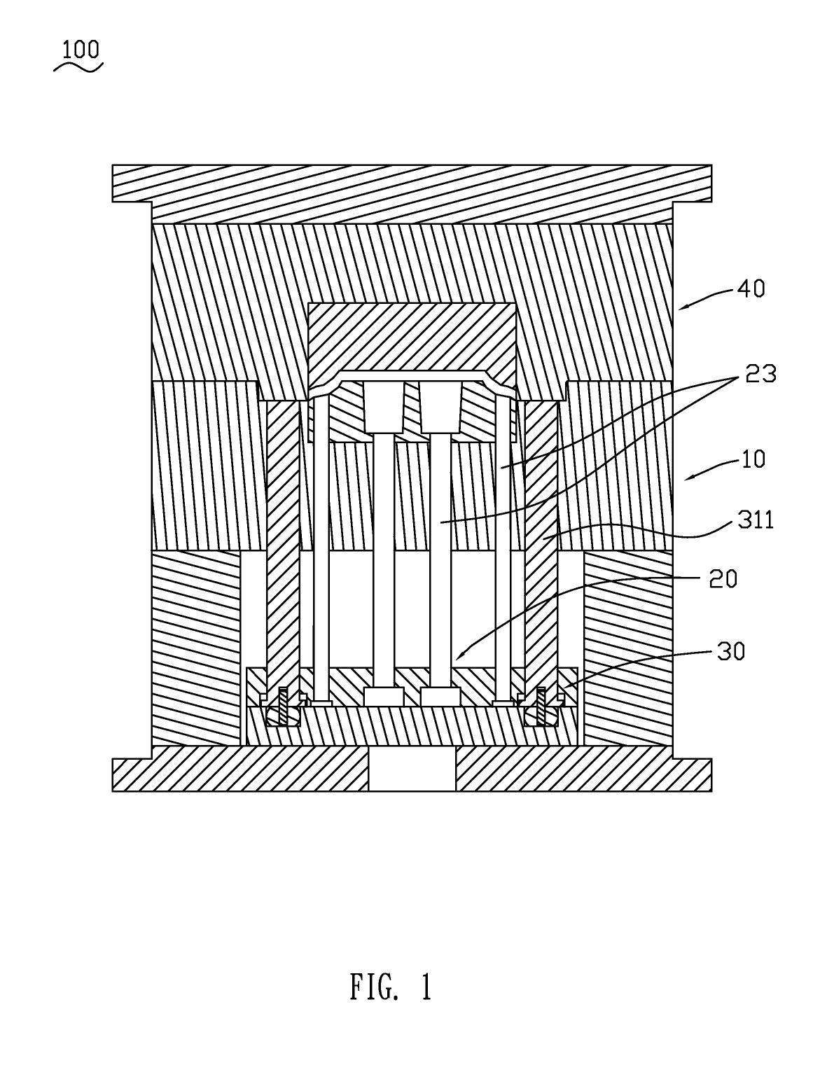

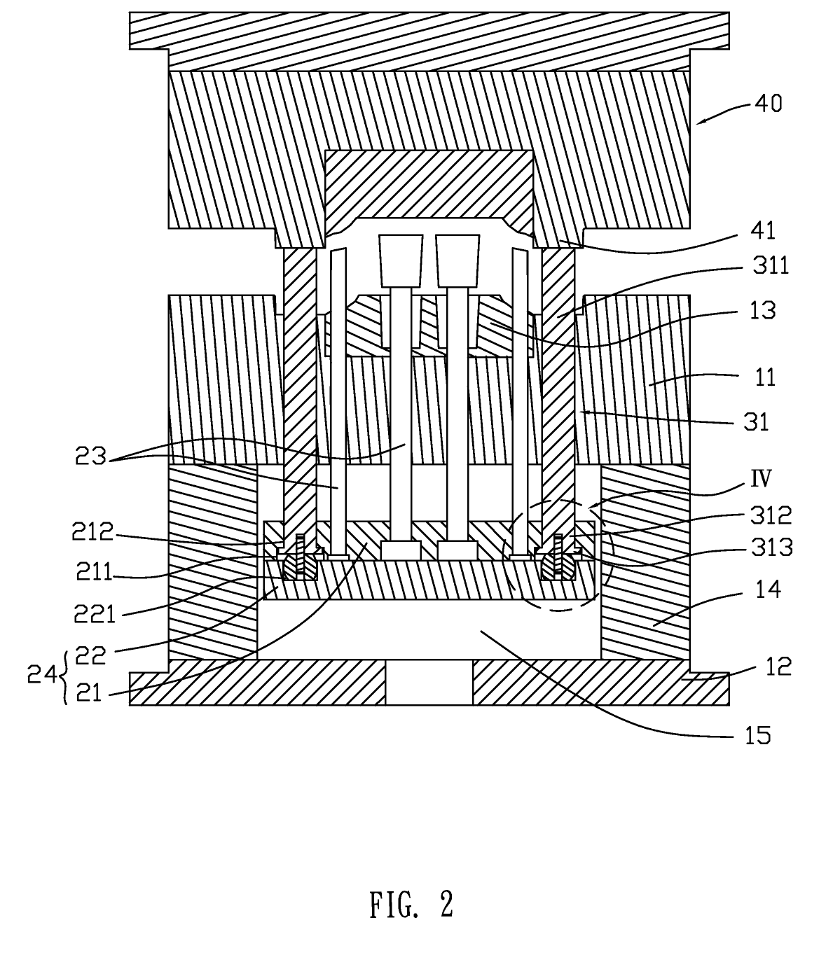

Please refer to FIG. 1 and FIG. 2. The mold 100 of the present invention comprises a moving half 40, a fixed half 10, a push-out structure 20 and a return protection system 30. The push-out structure 20 is installed on the fixed half 10. The return protection system 30 is installed on the push-out structure 20.

The moving half 40 has a pressing part 41. The fixed half 10 comprises a cavity fixing plate 11, a lower fixing plate 12, a pair of spacing blocks 14 positioned between the cavity fixing plate 11 and the lower fixing plate 12. A fixed half cavity 13 is fixed on the cavity fixing plate 11. An accepting space 15 is surrounded by the cavity fixing plate 11, the lower fixing plate 12 and the two spacing blocks 14 and formed thereby.

The push-out structure 20 comprises push-out elements 23 and a push-out plate 24 fox fixing the push-out elements 23. The push-out plate 24 comprises an upper push-out plate 21 and a lower push-out plate 22 fixed with each other. The push-out elements 23 are installed on the upper push-out plate 21 and fixed by the upper push-out plate 21 and the lower push-out plate 22 together. The tops of the push-out elements 23 can be planes or inclined planes in accordance with the product. The tops of the push-out elements 23 can extend out of the parting plane of the fixed half 10. Accordingly, the push-out elements 23 can push out the product when the mold 100 is opened. A limitation hole 211 and a pass hole 212, which is positioned above the limitation hole 211 and connecting with the limitation hole 211 are formed at the bottom of the upper push-out plate 21. An accepting slot 221 in accordance with the limitation hole 211 is formed on the lower push-out plate 22.

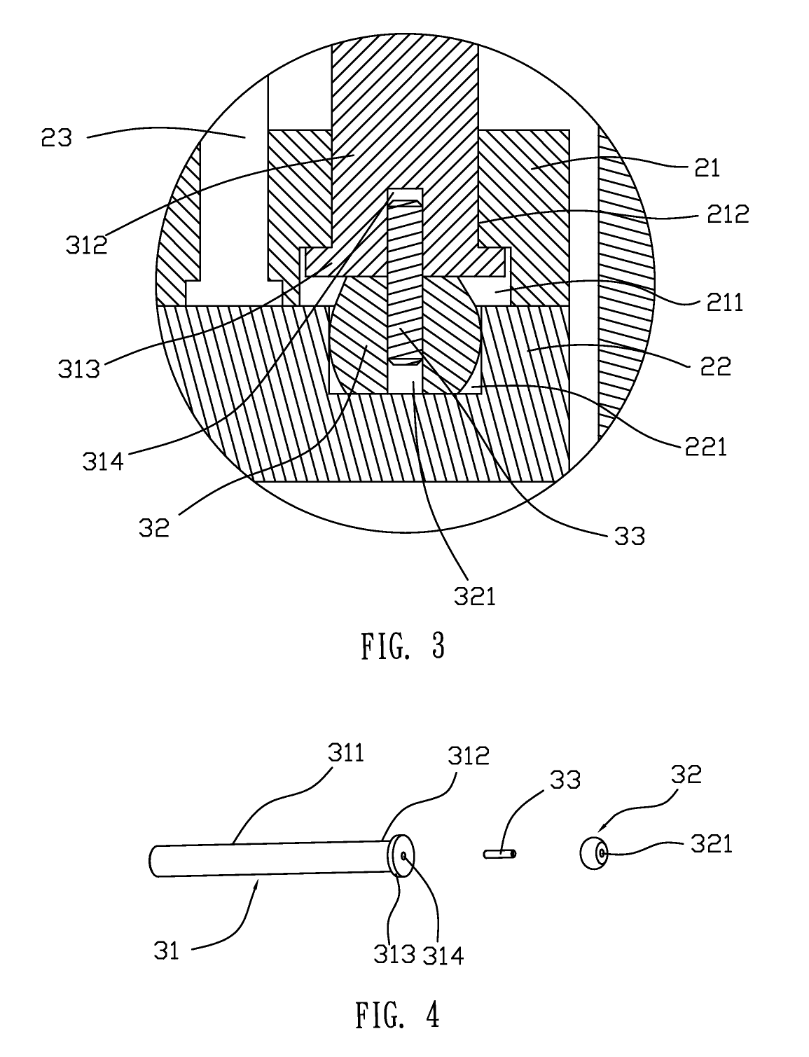

Please refer to FIG. 1, FIG. 2, FIG. 3 and FIG. 4. The return protection system 30 comprises a return pin 31 and an elastic element 32 and a location pin 33. The return pin 31 comprises a push end 311 and an assembly end 312. A resisting part 313 bulges outwards from the assembly end 312. The height of the resisting part 313 is smaller than the height of the limitation hole 211 (In this embodiment, the aforesaid height difference is about 5 millimeters). Therefore, the assembly end 312 can be slidably installed on the push-out plate 24. A pin hole 314 is formed upwards at the middle of a bottom surface of the return pin 31. The elastic element 32 is installed between the return pin 31 and the push-out plate 24. A through hole 321 is formed downwards on top of the elastic element 32 and through the elastic element 32. Besides, the height of the elastic element 32 is larger than the height of the accepting slot 221 (In this embodiment, the aforesaid height difference is about 5 millimeters). The top of the location pin 33 is fixed inside the pin hole 314 at the bottom of the return pin 31. The bottom end of the location pin 33 is positioned through the through hole 321 of the elastic element 32. In this embodiment, the elastic element 32 is manufactured by cushion glue.

When the return protection system 30 is assembled in the mold 100, the elastic element 32 is accepted in the accepting slot 221 and the top of the elastic element 32 dips into the limitation hole 211 upwards. The assembly end 312 of the return pin 31 presses against the elastic element 32. The resisting part 313 is up and down movably installed in the limitation hole 211 and the assembly end 312 outs of the pass hole 212 upwards. The push end 311 of the return pin 311 pass through the cavity fixing plate 11 and extends out of the parting plane of the fixed half 10.

Meanwhile, the push end 311 can be moved downwards and positioned in the cavity fixing plate 11 when the mold is closed.

Please refer to FIG. 1, FIG. 2 and FIG. 3. When the mold is closed in a close status, the pressing part 41 of the moving half 40 presses the push end 311 of the return pin 31. The assembly end 312 presses down the push-out plate 24 with the elastic element 32. The push-out structure 20 is positioned in the most bottom end of the accepting space 15. The top surface of the push-out element 23 is lower than or on a level with the prating plane of the fixed half 10.

When the mold is being opened, the elastic element 32 stretches up and presses the assembly end 312 to move the return pin 31 upwards. Because the return protection system 30 is installed on the push-out structure 20, the return protection system 30 and the push-out structure 20 can be moved upwards together and the push-out element 23 pushes out the product.

When the mold is being opened, the move half 40 is moved downwards and the pressing part 41 will press down the push end 311 of the return pin 31. The return pin 31 moves downwards to drive the push-out structure 20 downwards at the same time. Therefore, until the mold closing procedure is complete, the pressing part 41 of the move half 40 presses down the push end 311 of the return pin 31 but not interferes the push-out element 23. With the elasticity of the elastic element 32, the mold 100 is being closed slowly.

As aforementioned, the mold 100 of the present invention can prevent the moving half 40 to interfere the push-out element 23 and to impact the fixed half 10 because the return pin 31 can drive the push-out structure 20 with the elastic element 32. Accordingly, the lifetimes of the push-out structure 20 and the parting planes of the mold 100 can be extended to reduce the maintenance cost of the mold 100. Noise caused by closing mold 100 with high speed can be prevented to raise the stability and the productivity of manufacture.

As is understood by a person skilled in the art, the foregoing preferred embodiments of the present invention are illustrative rather than limiting of the present invention. For example, the sealing portion 222 can be formed on the moving half core 12. The bearing plates 24 can be raised from the fixed half plate 21 by machine work. Alternatively, the bearing plates 24 also can be positioned on the moving half plate 11. It is intended that they cover various modifications and similar arrangements be included within the spirit and scope of the appended claims, the scope of which should be accorded the broadest interpretation so as to encompass all such modifications and similar structure.

What is claimed is:

1. A mold, comprising:
a fixed half;
a moving half, having a pressing part;
a push-out structure, installed on the fixed half, comprising a push-out element and a push-out plate for fixing the push-out element; and
a return protection system, comprising a return pin and an elastic element, installed between the return pin and the push-out element;
wherein the pressing part can press against the return pin to drive the return pin and the return pin can drive the push-out structure to move downwards with the elastic element.

2. The mold of claim 1, wherein the return pin comprises an assembly end, slidably installed on the push-out plate, and the plate elastic element is manufactured by cushion glue and installed between the assembly end and the push-out plate.

3. The mold of claim 1, wherein a pin hole is formed at the middle of a bottom surface of the return pin of the assembly end, and a through hole is formed on the elastic element, and a location pin is fixed in the pin hole, and the bottom end of the location pin is positioned through the through hole of the elastic element.

4. The mold of claim 1, wherein the push-out plate comprises an upper push-out plate and a lower push-out plate fixed with each other; a limitation hole and a pass hole, which is positioned above the limitation hole and connecting with the limitation hole are formed on the upper push-out plate, and an accepting slot in accordance with the limitation hole is formed on the lower push-out plate; the resisting part bulges outwards from the assembly end and is up and down movably installed in the limitation hole, and the assembly end outs of the pass hole upwards, and the elastic element is accepted in the accepting slot and dips into the limitation hole upwards, and the assembly end presses against the elastic element.

5. The mold of claim 1, wherein the fixed half comprises a cavity fixing plate, a lower fixing plate, a pair of spacing blocks positioned between the cavity fixing plate and the lower fixing plate, and an accepting space is formed by the cavity fixing plate, the lower fixing plate and the two spacing blocks; the push-out plate is up and down movably positioned in the accepting space.
